(19) United States
(12) Patent Application Publication
(10) Pub. No.: US 2012/0267906 A1
(43) Pub. Date: Oct. 25, 2012

(54) DOOR MOUNTING

(76) Inventor: Herbert Meyerle, Maisach (DE)

(21) Appl. No.: 13/392,923

(22) PCT Filed: Aug. 27, 2010
(86) PCT No.: PCT/EP2010/062598

§ 371 Date: Apr. 23, 2012

(30) Foreign Application Priority Data
Aug. 28, 2009 (DE) 102009039011.1

(51) Int. Cl. E05B 9/02; B23P 11/00

(52) U.S. Cl. 292/337; 29/428

(57) ABSTRACT

The present invention relates to a door mounting having two door plates and a biasing element for biasing the two door plates against a door leaf and/or against each other under tension, wherein the biasing element lies in an insertion opening of the door leaf provided for a locking cylinder when the two door plates are fixed to the door leaf. According to the invention, the fixing of the door mounting is realized substantially without additional drilled holes and respective screws only by means of a biasing element. Since the biasing element is arranged within an already existing opening in the door leaf, the drilling of additional fixing holes in the door leaf is not necessary.

The present invention relates to a door mounting, particularly a door mounting having an electronically controlled authentication unit and a method for mounting the door mounting according to the present invention at a door leaf.

### BACKGROUND OF THE INVENTION

Door mountings having various kinds of electronic access control units are known. They often comprise pairs of door plates which are fixed to both surfaces of a door and which often have base elements having a panel construction, the base elements having openings for receiving units for operating the lock like latch pins, locking cylinders or the like and holes for receiving fixing screws. Fixing screws are usually used for fixing the door plates to the door leaf. In the case of security mountings, the fixing screws are usually only screwed from the inner surface of the door into bushings extending from the rear side of the outer door plate. Here, the fixing screws are, inter alia, used for biasing the door plates or mounting plates against the door leaf or to fix them relatively to each other. The fixing screws are received either in already existing holes of the door leaf or the holes have to be drilled prior to the mounting which is often made when the door is already mounted.

Disadvantages of such a mounting are that additional holes have to be drilled into the doors and that the diameter and locations thereof vary for the various mounting models and that the position/direction and the size of the holes to be drilled cannot be drilled highly accurately when the door is already mounted. Often, the holes are drilled somewhat greater than required in order to compensate for the drilling inaccuracy and ensure the fixing of the door mounting. However, it is a consequence thereof that the position of the door plates may change over the time. Furthermore, said fixing method provides the risk that the screwing loosens over the years. Additionally, it is often not possible or allowed (e.g., for fire doors) to drill holes into the door leaf at a desired position.

Thus, it is an object of the present invention to overcome the afore-mentioned disadvantages of the prior art and to provide an improved and particularly easily fixable electronic door mounting.

The object of the present invention is solved by the independent claims or the aspects discussed below. The dependent claims describe further preferred embodiments and derivations of the invention.

### SUMMARY OF THE INVENTION

The invention relates to a mounting, particularly a digital door mounting having an electronic access control unit, being suitable for doors being fixed/hinged at the right and/or left hand side. Particularly, the present invention relates to a door mounting having two mounting plates (in the following the terms “mounting plate” and “door plate” are used synonymously) and at least one biasing element for biasing the two door plates against the door leaf and/or against each other under tension and/or for fixing them to each other in a rigid manner, wherein the biasing element preferably lies in an already existing mounting opening of the door leaf/mortise lock. Usually, a door leaf comprises at least two openings, an upper opening for receiving a latch pin and a lower opening for receiving a locking cylinder, e.g. a profile cylinder (PZ-cylinder). Additionally, a box staple (mortise lock) can usually be inserted into a door leaf, wherein the box staple also comprises at least two openings being analogous to the two openings in the door leaf and being aligned therewith.

Preferably, the two door plates are biased against the door leaf or each other by exactly one biasing element, e.g. exactly one opening in the door leaf is sufficient in order to fix the mounting according to the present invention. Additionally to this single biasing element a latch pin is mounted in order to operate the catch and optionally additionally or alternatively the latch of the box staple.

When pushing the door handle, forces are generated which are received by the door plates according to the present invention and the biasing element according to the present invention and/or the latch pin, or these forces are transferred to the opposite side of the door leaf and are transferred via the door plates to the door leaf in such a manner that a torsion of the door plate is avoided.

According to a preferred embodiment, the biasing element is mounted to or fixed at a door plate, preferably both door plates, at a fixing position in order to fix the mounting according to the present invention. The fixing position at the door plate is adapted to the size of the box staple. In following, the indication of the directions “up” and “down” relate to correctly mounted door plates like those often used in Germany. In such mountings, e.g., the latch pin is arranged in an upper part of the door plate and the position at which the locking cylinder is usually inserted is arranged in a lower part of the door plate. In other countries (e.g., in the USA), however, this arrangement can be vice-versa, i.e., the latch pin is in the lower part and the locking cylinder is in the upper part. A person skilled in the art will acknowledge that the following position indications have to be adapted accordingly for mountings originating from other countries. Additionally, a geometrical connecting line (axis) can be drawn between the latch pin or a receipt/opening for the latch pin provided in the door mounting and the position at which a locking cylinder is usually inserted, wherein the fixing position of the biasing element should lie within said connecting line/axis in order to avoid a rotating of the door mounting while used. According to the present invention, this axis is parallel to gravitation when the door mounting is correctly fixed. This fixing position is preferably on the axis, particularly between the upper edge of the latch pin and the lower edge of the locking cylinder, when the door mounting is fixed to a door leaf.

In other words, a single biasing element or multiple biasing elements can be inserted in a single or multiple opening(s) in the door leaf, the opening(s) lying between the opening for the latch pin and the opening for the PZ-, oval or round cylinder. Alternatively or additionally, an opening can also be generated lying between the opening of the latch pin and the opening for the PZ-, oval or round cylinder which is then used for receiving the biasing element. Even when the mounting of the present invention is subsequently replaced by a conventional short mounting the opening generated would be covered by the plates of the short mounting, i.e., the additional opening would not be visible from the outside. According to a preferred embodiment the opening for fixing the door mounting according to the present invention lies on the connecting line opening for the latch pin—opening for the locking cylinder, preferably between the lower edge of the opening for the latch pin and the lower edge of the opening for the locking cylinder, wherein also the opening for the locking cylinder complies with this condition. A person skilled in the art will acknowledge that the direction indications for a corresponding US system in which the latch pin is arranged below the locking cylinder should be adapted accordingly.

With regard to the proper door mounting, this means that the door mounting is designed in such a manner that the at least one biasing element can be fixed to the two mounting plates each at a position which, when the mounting is correctly fixed, is below the latch pin and the distance to the latch pin is smaller than or equal to the normal distance between the opening for the latch pin and the opening for the locking cylinder.

A particular advantage of the present invention is that the biasing element or the biasing elements is/are arranged between the latch pin and the locking cylinder or the opening provided for the locking cylinder. In the following only one of the possible biasing arrangements is described in more detail.

According to the present invention, the fixing of the door mounting is performed preferably substantially without drilling of additional holes and corresponding screws in the door leaf, i.e., only by means of the at least one biasing element. Since the biasing element can preferably be arranged within an already existing opening in the door leaf, the drilling of additional fixing holes in the door leaf is not necessary. This means, advantageously the two door plates are substantially biased with tension against each other or against the door leaf by means of the at least one biasing element; additional screwed connections between the door plate and door leaf are preferably avoided.

This has the decisive advantage that an inaccurate fixing due to an insufficient drilling accuracy can be avoided. Additionally, the door mounting according to the present invention has the decisive advantage that it is also suitable for fire doors for which the drilling of holes is only possible or allowed under certain conditions.

Preferably, one or both door plates comprise(s) an opening or guide for inserting a latch pin and/or for fixing a door latch/door handle. Preferably a door plate has a box-shaped profile. A box-shaped profile has the advantage that the rigidity of the door plate against distortion or bending is increased.

Preferably the biasing assembly is performed in a manner preferably rigid against distortion and having no play in order to ensure a defined position of the door plates to each other and to receive torques introduced on one side by the respective opposite side.

In a further embodiment the latch pin is capable to transfer parts of the torques to the respective other side. Therefore, the bearing thereof in preferably one of the two door plates for receiving external torques (forces) around the vertical axis of the mounting is provided with small play and maximum rigidity. The thus achieved alignment being substantially exact and free from play of the latch pin effects together with the biasing assembly a defined parallel position of the door plates to each other.

In other words, an essential aspect of the present invention is the providing of a door mounting in which the doorplates are aligned in parallel to each other and remain in this position even if external forces are exerted onto the latch.

Since the access control is preferably not provided by conventional locking cylinders but by electronically engaging and releasing of at least one of the latches, the fixing of the door mounting according to the invention can preferably be provided in the location at the door leaf provided for the locking cylinder.

The door mounting according to the present invention preferably fulfills the requirements for its use in the field of hospitality and residential homes for elderly persons. The door mounting according to the invention preferably wirelessly communicates with identification media by means of digital locking and access control systems and controls the access, and, additionally or alternatively, can also be operated online via a direct wiring.

Additionally, it is advantageous when the outer latch is not connected via a conventional latch pin with the inner latch. Preferably the connection of the inner latch and the outer latch is performed by a thinner latch pin. According to a further embodiment, the latch pin can be supported with play in the latch(es) so that the (leverage) torques around the vertical or horizontal axis of the door plate is not transferred directly via the latch pin to the latch of the opposite side of the door leaf. Additionally or alternatively, the latch pin can also be provided with a joint, preferably a cardan joint, transferring the rotational movement of the latch for operating the catch via the latch pin to the latch on the other side of the door. Other forces, e.g. leverage forces around the vertical or horizontal axis of the door plate which might effect a displacement of the door plate(s), are not transferred or only to a highly diminished extent. In other words, a connection between latch pin and latch is provided which is necessary for transferring an operation torque (rotating of the latch pin around its longitudinal axis to operate the catch), but comprises sufficient tilting play against torques around the vertical and horizontal axes of the door plate.

Preferably, the biasing element is formed in a manner rigid against distorting. Thereby, it is achieved that mechanical torques around the vertical and/or horizontal axis of the mounting introduced at the latch on one side are transferred via the biasing element, the biasing element being rigid against distortion or bending, to the respective opposite door plate so that such torques can be received by both door plates and an undesired support via the latch pin is avoided.

Preferably at least one door plate is fixedly connected to the biasing element, e.g. fixedly screwed or welded. According to this embodiments a door plate together with the biasing element can be mounted to the door from one side whereby the biasing element is inserted into the opening in the door leaf provided for the locking cylinder. The second door plate can be subsequently connected, e.g., by screwing, to the biasing element which lies in the PZ opening. This means, the second door plate can be connected with the biasing element by means of a connection being different from the one of the first door plate to the biasing element.

According to a further embodiment, both door plates can be detachably connected with the biasing element, i.e. concurrently to or only shortly before fixing the door plates are connected to the biasing element. Furthermore, both door plates can be connected to the biasing element by means of an identical or different connection. Preferably the two door plates are concurrently or subsequently biased against each other or against the door leaf.

Preferably, at least one door plate comprises a long hole, wherein the biasing element engages with the long hole in such a manner that a biasing of the door plates against each other is possible. For example, the biasing element can extend beyond the long hole and can be relocatable along the long hole for mounting purposes. Such a connection has the advantage that, e.g., the position of the connection of the biasing element with the at least one door plate can be changed in vertical and/or horizontal direction and/or by rotation, so that, e.g., the distance between the biasing element and the latch axis can be adjusted depending on the depth gauge of a lock inserted into the door leaf.

Further preferred, the biasing element comprises at least two components (in the following also referred to as biasing element components), wherein a first component is connected or connectable to a first door plate and preferably the second component is connected or connectable to the second door plate. Preferably, both components are relocatable against each other for biasing; for example, by biasing the two door plates the two biasing components can lie in a form-fit manner to each other. Preferably, both components can be displaced against each other so that the dimension or the length of the biasing element between the door plates can be varied in order to adapt the mounting to various thicknesses of the door leaf and/or in order to bias the two door plates against each other.

Preferably, the two components of the biasing element can be screwed to each and are preferably arranged coaxially around an axis to each other. For example an inner component of the biasing element can comprise an outer thread and the other component can comprise a corresponding inner thread. For example, the two components of the biasing element can be biased and/or displaced against each other by at least one screw, wherein the two components and the screw are preferably arranged coaxially around an axis to each other.

According to a further preferred embodiment, the door mounting according to the present invention comprises a cover over the door plates wherein the connection between the biasing element and the door plate is not visible from the outside.

According to a further preferred embodiment, at least one mounting plate on the side facing the door leaf comprises at least one and preferably two or more elevated contact surface(s) either above or below or above and below the biasing element, the contact surface(s) defining the vertical distances between the application of the supporting forces and the biasing element. The contact surfaces are preferably formed in such a manner that a frictional connection between the door leaf and the contact surfaces is achieved. The elevated contact surfaces on the door plates are preferably elastically attached to the door plate or preferably consist of an elastic material so that they displace or deform when the biasing force is applied so that their elevation entirely or partly diminishes on the side facing the door leaf.

According to a further preferred embodiment, at least one door plate comprises at least one, preferably two, elastomeres at the surface facing the door leaf, said elastomere(s) lying between the door leaf and the door plate when the door plates are biased against each other.

The door mounting according to the present invention can preferably be mounted to all conventional doors having an opening for a locking cylinder. Preferably the door mounting according to the present invention complies with the requirements of the German standards DIN 18255 or DIN EN 1906

In order to ensure a secure fitting of the biasing element within the door leaf, the biasing element can be arranged substantially in a form-fit manner within the opening provided for the locking cylinder (also referred to as locking cylinder opening or profile cylinder (PZ) opening) of a mounted mortise lockbox staple.

Besides the door mounting according to the present invention, the present invention also relates to a method according to the invention for fixing a door mounting, and particularly a door mounting according to any one of the preceding aspects, comprising the steps of: arranging a first door plate preferably including the respective—firstly still vertically relocatable—(first) biasing element component at a first surface of the door leaf, wherein the (first) biasing element component is inserted into the opening of the door leaf provided for a locking cylinder; arranging a second door plate including the respective—firstly still vertically relocatable—(second) biasing element component at the opposite surface of the door leaf, wherein the (second) biasing element component is also inserted into the opening provided for a locking cylinder on the opposite side of the door leaf; adjusting and fixing of the vertical relocatability of the two biasing element components relative to the corresponding door plates so that a form-fit connection of the two biasing element components is achieved; ensuring a mechanical connection between the first door plate and the second door plate in such a manner that a biasing of the first and second door plates against each other and/or against the door leaf is possible wherein a biasing force is generated in that the size or the length of the biasing element—which is formed by the two biasing element components—is shortened, if necessary.

The door mounting according to the present invention can additionally be characterized by the following aspects.
1. A door mounting (42) particularly comprising an integrated electronic access control unit and
   two door plates (1), wherein at least one door plate comprises a receipt for a latch pin and/or a latch pin; and
   one or more biasing element(s) (2) for biasing the two door plates (1) with tension against each other;
   wherein the one or the multiple biasing element(s) (2) is/are in a position at the door leaf when being fixed which lies within a line between the latch pin and an opening (200) provided for the locking cylinder.
2. The door mounting according to aspect 1, wherein the door plates (1) comprise a support for the latch pin (30) having the purpose to possibly adjust the door plates in parallel, the support being rotatable but having substantially no play around the vertical axis of the mounting.
3. The door mounting according to aspect 1 or 2, wherein one biasing element (2) lies within the insertion opening (200) of the door leaf or mortise lock provided for the locking cylinder when a door mounting is fixed to a door leaf.
4. The door mounting according to any one of aspects 1 to 3, wherein the two door plates (1) are substantially biased against each other with tension by exactly one biasing element (2).
5. The door mounting according to aspect 4, wherein at least one door plate (1) is fixedly connected to the biasing element (2), for example being screwed or welded thereto.
6. The door mounting according to aspect 4 or 5, wherein the position of the connection between the biasing element (2) and the door plates (1) is vertically relocatable, so that the distance (d) between the biasing element (2) and the latch axis (30) can be adjusted depending on the gauge length of a lock fixed to the door leaf.
7. The door mounting according to any one of aspects 4 to 6, wherein the biasing element (2) provides a connection between the door plates being rigid against torsion and having substantially no play, so that torques applied to a door plate are transferred to the corresponding opposite door plate (1).
8. The door mounting according to any one of aspects 4 to 7, wherein the mounting element (2) comprises at least two components, wherein a first component (21) can be connected to a first door plate (1) and preferably the second component (22) can be connected to the second door plate (1), and wherein the two components (21, 22) are displaceable against each other so that the extension (a) of the biasing element (2) between the door plates (1) can be shortened in order to adapt the mounting to various thicknesses of the door leaf and/or to bias the two door plates (1) against each other.
9. The door mounting according to aspect 8, wherein the two components (21, 22) of the biasing element (2) can be screwed to each other and are preferably arranged coaxially to each other around an axis (A).
10. The door mounting according to aspect 8 or 9, wherein the two components (21, 22) of the biasing element (2) can be displaced/biased against each other by means of at least one screw (23), wherein the two components (21, 22) and the screw (23) are preferably arranged coaxially to each other around an axis (A).
11. The door mounting according to any one of the preceding aspects, wherein at least one door plate (1) comprises at least one, and preferably two, elevated contact surfaces (4) either above or below or above and below the biasing element (2) on the surface facing the door leaf (100), the contact surfaces defining the vertical distances of the applications of the supporting forces to the biasing element, wherein the contact surfaces (2) are preferably configured in such a manner that a frictional connection between the door leaf (100) and the contact surfaces (4) is achieved.
12. The door mounting according to aspect 11, wherein the elevated contact surfaces (4) are elastically attached to the door plate (1) or consist of an elastic material so that, when applying the biasing force, the contact surfaces displace or deform in such a manner that the elevation thereof entirely or partly diminish at the surface facing the door leaf (100).
13. The door mounting according to any one of the preceding aspects, wherein the door mounting complies with German standards DIN 18255 or DIN EN 1906.
14. The door mounting according to any one of aspects 4 to 13, wherein the biasing element (2) lies in a substantially form-fit manner within the PZ-opening of a mortise lock/box staple inserted into the door leaf (100).
15. A method for fixing a door mounting, particularly a door mounting (42) according to any one of the preceding aspects, comprising the steps:
   (i) inserting a biasing element (2) into an insertion opening of a door leaf;
   (ii) arranging a first door plate (1) on one surface of the door leaf;
   (iii) arranging a second door plate (2) on the opposite surface of the door leaf; and
   (iv) biasing the first and second door plates against each other and/or against the door leaf.

Furthermore, a door mounting according to the present invention can also be characterized by the following additional aspects.
16. A door mounting having: two door plates and a biasing element for biasing the two door plates against a door leaf and/or against each other under tension, wherein the biasing element is provided in an insertion opening provided for the locking cylinder in the door leaf
17. The door mounting according to aspect 16, wherein the door mounting comprises an electronic access control unit.
18. The door mounting according to aspect 16, wherein the biasing element is provided in an insertion opening (200) of the door leaf or the mortise lock provided for the locking cylinder.
19. The door mounting according to any one of aspects 16, 17 or 18, wherein at least one door plate comprises an opening or guide for inserting a latch pin and/or a bearing for supporting, particularly without play, a door latch/door handle.
20. The door mounting according to any one of aspects 16 to 19, wherein the two door plates are substantially biased against each other under tension only by the biasing element.
21. The door mounting according to any one of aspects 16 to 20, wherein at least one door plate is fixedly connected with the biasing element, for example by screwing or welding.
22. The door mounting according to any one of aspects 16 to 21, wherein at least one door plate can be mechanically engaged with the biasing element, for example connectable by means of a groove.
23. The door mounting according to aspect 21 or 22, wherein the position of the connection between the biasing element and the at least one door plate can be varied in the vertical direction so that the distance between biasing element and latch axis can be varied depending on the depth gauge of a lock inserted into the door leaf.
24. The door mounting according to any one of the preceding aspects 16 to 23, wherein the biasing element is configured in a manner rigid to torsion so that particularly torques applied around the vertical axis of the mounting on one side are transferred via the torsion-rigid biasing element to the respective opposite door plate so that such torques are received by both door plates.
25. The door mounting according to any one of the preceding aspects 16 to 24, wherein the biasing element comprises at least two components wherein a first component can be connected with a first door plate and preferably the second component with the second door plate, and wherein the two components can be displaced against each other so that the extent (a) of the biasing element between the door plates can be shortened in order to adapt the mounting to various thicknesses of the door leaf and/or to bias the two door leafs against each other.
26. The door mounting according to aspect 24, wherein the two components of the biasing element (2) can be screwed to each other and are preferably arranged coaxially around an axis (A) to each other.
27. The door mounting according to aspect 24 or 25, wherein the two components of the biasing element can be displaced/biased by at least one screw wherein the two components and the screw are preferably arranged coaxially around an axis to each other.
28. The door mounting according to any one of the preceding aspects 16 to 27, wherein at least one of the door plates is at least partially U-shaped or partially box-shaped.
29. The door mounting according to any one of preceding aspects 16 to 28, wherein at least one door plate comprises at least one and preferably two elevated contact surface(s) either above or below or above and below the biasing element at the surface facing the door leaf, the contact surfaces defining the vertical distances of the applications of the supporting force to the biasing element, wherein the contact surfaces are preferably configured in a manner such that a frictional connection between the door leaf and the contact surfaces is achieved.
30. The door mounting according to aspect 27, wherein the elevated contact surfaces are elastically attached to the door plate or consist of an elastic material so that they deform or displace when applying the biasing force so that their elevation at the surface facing the door leaf diminishes partially or entirely.
31. The door mounting according to any one of aspects 16 to 30, wherein at least one door plate comprises at least one, preferably two, elastomere(s) on the surface facing the door leaf, the elastomere(s) lying between the door leaf and the door plate when biasing the door plates.
32. The door mounting according to any one of the preceding aspects 16 to 31, wherein the door mounting fulfills German standard DIN 18255 or DIN EN 1906.
33. The door mounting according to any one of preceding aspects 16 to 32, wherein the biasing element lies in a substantially form-fit manner within the PZ-opening of a mortise lock/box staple inserted in the door leaf
34. A method for fixing a door mounting, particularly a door mounting according to any one of the preceding claims, comprising the steps:
   (i) inserting a biasing element in an insertion opening of a door leaf provided for a locking cylinder;
   (ii) arranging a first door plate at one side of the door leaf;
   (iii) arranging a second door plate at the opposite side of the door leaf; and
   (iv) biasing of the first and second door plates against each other and/or against the door leaf.

Furthermore, the invention relates to a door mounting, particularly with an integrated electronic access control unit and two door plates, wherein at least one door plate comprises a receipt for the latch pin and/or a latch pin, and at least one biasing element, in order to bias under tension the two door plates against each other, wherein the biasing elements are arranged in a position which is within a line between the latch pin and including the locking cylinder.

The invention also comprises some features in the Figures, even if they are indicated therein in connection with other features and/or are not mentioned above and/or below.

The invention also embraces embodiments having any combination of features which are mentioned in relation to various embodiments above or below.

### BRIEF DESCRIPTION OF THE FIGURES

In the following, preferred embodiments of the present invention are described in detail with reference to the Figures.

FIG. 1 shows a lateral sectional view of a door mounting according to the invention.

FIG. 2 also shows a lateral sectional view of a further preferred embodiment of the door mounting according to the present invention.

FIG. 3 shows a perspective view of a door mounting set according to the invention; and

FIG. 4a, b shows conventional door latches with an indication of the forces which occur when operating the latch.

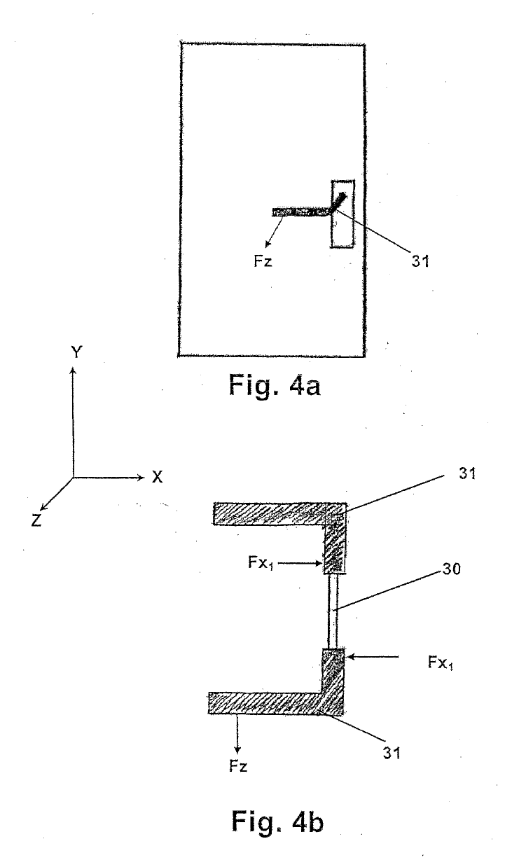

### DETAILED DESCRIPTION OF PREFERRED EMBODIMENTS

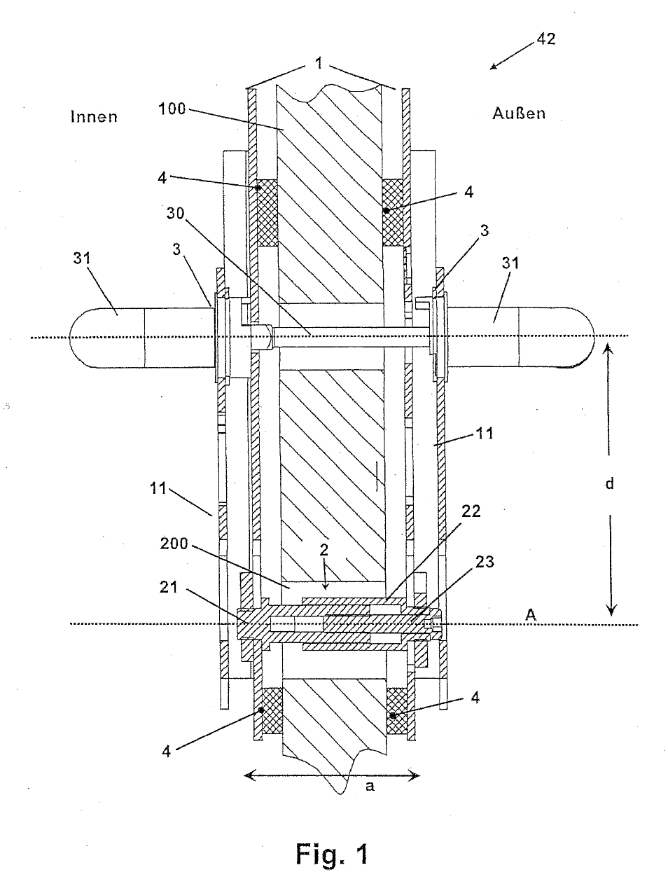

In FIG. 1 a door leaf of a door is referred to with reference sign 100. A box staple which can be inserted into the interior of the door leaf 100 in the known manner from the small side of the door leaf is not indicated for the purpose of a better overview.

In the area in which the box staple is inserted, the door plates 1 are fixed from the outside on both sides of the door leaf 100, the door plates receiving or supporting rotatable door handles 31, wherein the door handles 31 in turn are connected via the latch pin 30 to each other in a rotational-fit manner. According to a preferred embodiment, the inner door side is permanently coupled to the latch pin, i.e., from the inner side of the door, the catch or bar can be operated by operating the latch. However, the latch of the outer side of the door preferably only couples when successfully authentifying of an entitled user, i.e., when the authentification is not successful the outer latch rotates in void, while, after a successful authentification, the outer latch is coupled via a coupling mechanism not described in detail with the latch pin. According to a further embodiment, there can also be provided an authentification on both, the inner side and the outer side of the door.

The door plates 1 are covered by a cover (not shown) having respective openings. Particularly, the door plate 1 comprises a guide for guiding or rotatably supporting the door handles 31.

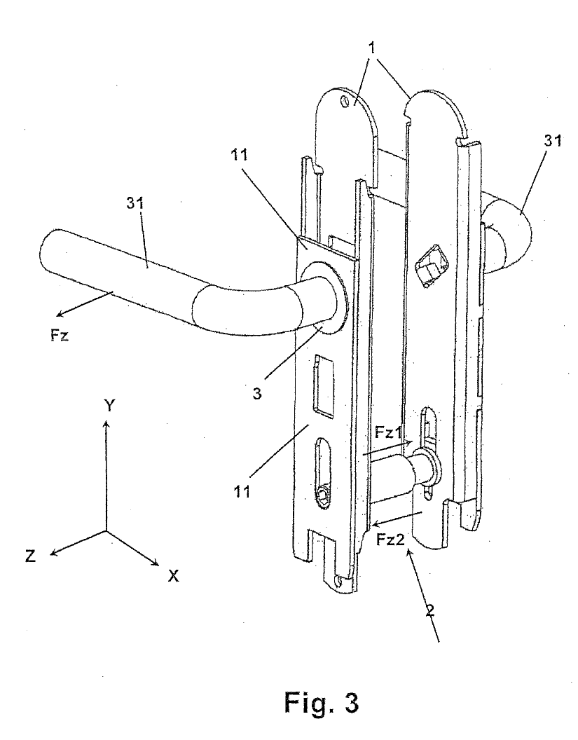

The door plates 1 are either flat or have a profile along their cross section, e.g. a U-shaped profile, whereby the rigidity of the door plates can be increased, where appropriate. In order to achieve an additional rigidity, particularly rigidity against torsion or torsional stiffness and/or rigidity against bending, the door plate according to the present invention can also comprise a box element 11 or can be configured as a box (see FIG. 3). For example, a cover 11 is fixedly attached, preferably welded, to a door plate having a U-shaped profile (see FIGS. 1-3). It is, however, preferred that flat contact surfaces of the door plates are directed against each other and against the door or against the door leaf 100. A particularly torsionally rigid door plate is advantageous, since by combining torsionally rigid door plates 1 with the torsionally rigid biasing element 2, torques can be transferred via the door plates 1 and the biasing element 2 to the opposite side of the door, whereby a displacement or releasing or tilting of the door plates can be avoided due to the absence of a screw above the latch 31. Preferably the mounting is formed by a rigid box profile, the mounting comprising a U-profile (door plate) 1 and a cover 11, wherein the flat side of the U-profile 1 presses against the door leaf Preferably, the door latches 31 are supported preferably without play via a bearing 3 at the door plate and/or the cover.

According to the embodiment shown in FIG. 1, elevated contact surfaces 4 (dimensionally exaggerated in the Figure) are formed at the surface of the door plate 1 facing the door leaf 100. In the embodiment shown, they are elastomeres or the like which are compressible, i.e., when mounting the door plates, the elastomeres 4 are compressed. Thereby a displacement of the door plates relative to the door leaf is avoided even if external forces are exerted to the door latches when the door is permanently operated. In other words, external forces exerted to the door latch are evenly transferred and distributed from the door latch via the door plate to the door leaf by the elastomeres 4. Particularly, also forces exerted at the outside are transferred via the torsionally rigid biasing element 2 to the door plate at the inner side of the door and vice-versa.

The two door plates 1 are pressed or biased against each other by means of the biasing element 2, wherein the biasing element is located in the opening 200 of the door leaf (and optionally in the opening of the box staple) which is provided for inserting a locking cylinder. The biasing element 2 according to the embodiment shown in FIG. 1 consists of at least two components wherein a first component is connected to the door plate of the inner side of the door and the second component is connected to the door plate of the outer side of the door when mounted. The connection between the biasing element 2 and the door plates is not limited to a certain mounting technique. For example, one can think of a welded connection, screwed connection and/or connections which allow a biasing, e.g., a guide rail in the door plate and pins which engage the guide rail. For example, a guide rail may be particularly advantageous in a door plate in order to enable an adjusting or vernier adjusting of the distance “d”, e.g., the distance between the latch pin 30 and PZ-opening 200 (door depth gauge). Additionally it may be advantageous, when a displacement in horizontal direction and/or a rotation of the two door plates is possible.

In the embodiment shown in FIG. 1, the two components of the biasing element are cylindrically arranged around a common axis, wherein the left biasing component 21 is arranged within the outer biasing component 22. The extent or distance “a” of the biasing element 2 is shortened for biasing the door plates against each other. In the embodiment shown, this is achieved by screwing screw 23 into the inner thread of the left biasing component 21.

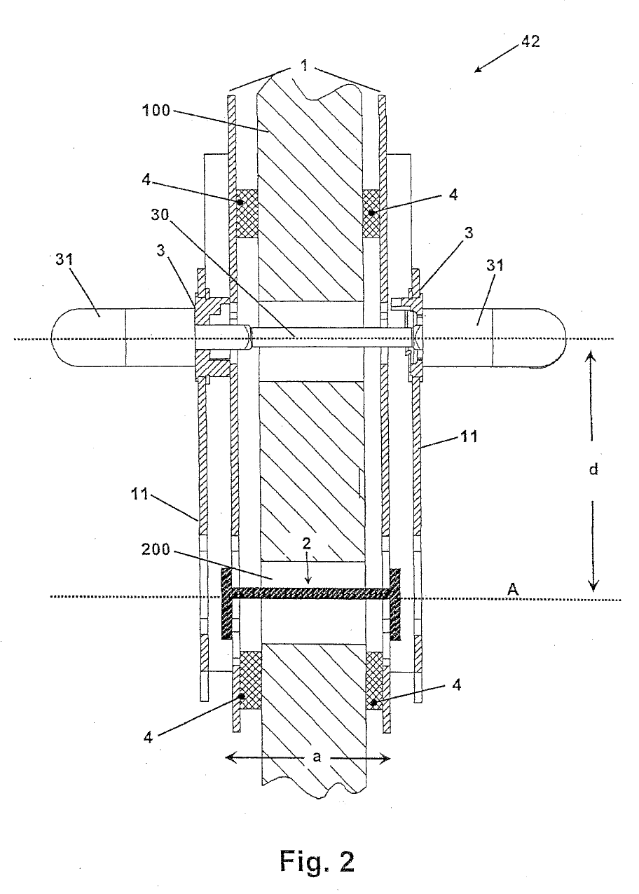

FIG. 2 shows a further preferred and simpler embodiment of the door mounting according to the present invention. The embodiment of FIG. 2 differs from the embodiment of FIG. 1 only in the biasing element 2. Particularly, in this embodiment the biasing element 2 does not consist of multiple components but only of a simple device which generates a biasing force between the two door plates by shortening the distance a, preferably by a thread or catch mechanism.

FIG. 3 shows a perspective view of an embodiment similar to the one of FIG. 1. Particularly, the two door plates of the mounting set shown is configured as box-shaped mountings whereby a high degree of torsional rigidity is achieved. A latch pin, as well as covers for covering the mountings are not shown.

Since additional drilling holes which should limit the movement of the mounting relative to the door to a minimum when it is pulled at the latch are avoided for fixing the mounting at the door it is necessary to transfer the tension force Fz via a support without play of the latch in the door plate and furthermore via the torsional rigid and bending rigid embodiment of the door plate (1) to the biasing element (2). Furthermore, a latch pin (30) is supported in the latches (31) in such a manner that torques can be substantially transferred without play but has more play in at least another direction as can occur due to the play in the support of the latch (31) in the door plate (1) and a deformation of the door plate (1) due to forces.

The invention also comprises the accurate or exact terms, features, numerical values or ranges etc., when these terms, features, numerical values or ranges are mentioned for example in connection with the terms “approximately, ca., about, substantially, generally, at least” etc. (eg., “about 3” should also mean “3” or “substantially radial” should also mean “radial”).

1. A door mounting particularly having an integrated electronic access control unit and
two door plates, wherein at least one door plate comprises a receipt for a latch pin and/or a latch pin; and
one or multiple biasing element(s) for biasing the two door plates against each other under tension;
wherein, when being fixed, the one or multiple biasing element(s) are in a position at the door leaf, the position lying within a line between the latch pin and an opening provided for a locking cylinder.

2. The door mounting according to claim 1, wherein the door plates comprise a support of the latch pin, being rotatable but having substantially no play around the vertical axis of the latch, in order to preferably adjust the door plates in parallel.

3. The door mounting according to claim 1, wherein a biasing element lies in the insertion opening provided for the locking cylinder of the door leaf or mortise lock in a door mounting fixed to the door leaf.

4. The door mounting according to claim 1, wherein the two door plates are biased against each other under tension by substantially exactly one biasing element.

5. The door mounting according to claim 4, wherein at least one door plate is fixedly attached with the biasing element, e.g., by screwing or welding.

6. The door mounting according to claim 4, wherein the position of the connection between the biasing element and the door plates is variable in the vertical direction so that the distance (d) between the biasing element and the latch axis is adjustable depending on the depth gauge of a lock inserted into the door leaf.

7. The door mounting according to claim 4, wherein the biasing element provides a connection between the door plates being rigid to bending and having substantially no play, so that torques applied to a door plate are transferred to the corresponding opposite door plate.

8. The door mounting according to claim 4, wherein the biasing element comprises at least two components, wherein a first component can be connected with a first door plate and preferably the second component can be connected to the second door plate, and wherein the two components are displaceable relative to each other, so that the extent (a) of the biasing element between the door plates can be shortened in order to adjust the door mounting to various thicknesses of the door leaf and/or to bias the door plates against each other.

9. The door mounting according to claim 8, wherein the two components of the biasing element can be screwed to each other and are preferably arranged coaxially to each other around an axis (A).

10. The door mounting according to claim 8, wherein the two components of the biasing element can be displaced/biased against each other by means of at least one screw, wherein preferably the two components and the screw are arranged coaxially to each other around an axis (A).

11. The door mounting according to claim 1, wherein at least one door plate comprises at least one, and preferably two, elevated contact surface(s) either above or below or above and below the biasing element at the surface facing the door leaf, the elevated surface(s) defining the vertical distance from the application of the supporting forces to the biasing element, wherein the contact surfaces are preferably configured in such a manner that a frictional connection between the door leaf and the contact surfaces is achieved.

12. The door mounting according to claim 11, wherein the elevated contact surfaces are elastically attached to the door plate or consist of an elastic material so that, when applying the biasing force, they displace or deform in such a manner that the elevation at the surface facing the door leaf diminishes entirely or partially.

13. The door mounting according to claim 1, wherein the door mounting fulfills the German standards DIN 18255 or DIN EN 1906.

14. The door mounting according to claim 4, wherein the biasing element lies in a substantially form-fit manner within the PZ-opening of a mortise lock/box staple inserted into a door leaf.

15. A method for fixing a door mounting, particularly a door mounting according to any one of the preceding claims, comprising the steps:
(i) inserting a biasing element in an insertion opening of a door leaf;
(ii) arranging a first door plate at a side of the door leaf;
(iii) arranging a second door plate at the opposite side of the door leaf; and
(iv) biasing the first and second door plates against each other and/or against the door leaf.
